(19) United States
(12) Patent Application Publication
(10) Pub. No.: US 2006/0064594 A1
(43) Pub. Date: Mar. 23, 2006

(54) Absorptive coating on a disc to create a reflective modulation for encryption

(75) Inventor: Nabil M. Lawandy, Saunderstown, RI (US)

Correspondence Address: KIRKPATRICK & LOCKHART NICHOLSON GRAHAM LLP;(FORMERLY KIRKPATRICK & LOCKHART LLP), 75 STATE STREET, BOSTON, MA, 02109-1808, US

(73) Assignee: Spectra Systems Corp., Providence, RI (US)

(21) Appl. No.: 11/167,650

(22) Filed: Jun. 27, 2005

Related U.S. Application Data
(63) Continuation-in-part of application No. 10/665,837, filed on Sep. 18, 2003.
(63) Continuation-in-part of application No. 10/702,530, filed on Nov. 5, 2003.
Application No. 10/702,530 is a continuation-in-part of application No. 10/165,273, filed on Jun. 6, 2002.
(60) Provisional application No. 60/296,308, filed on Jun. 6, 2001.
(60) Provisional application No. 60/310,914, filed on Aug. 8, 2001.
(60) Provisional application No. 60/311,160, filed on Aug. 9, 2001.
(60) Provisional application No. 60/435,647, filed on Dec. 20, 2002.
(60) Provisional application No. 60/412,153, filed on Sep. 18, 2002.
(60) Provisional application No. 60/489,945, filed on Jul. 22, 2003.

(51) Int. Cl. H04L 9/00

(52) U.S. Cl. 713/176

(57) ABSTRACT

Described herein are systems and methods for digital data encryption, and more specifically, systems and methods for providing encryption keys for reading encrypted data. Optical media, particularly digital disks, are described where a laser reader accesses digital data on a disk. The disks are coated with a coating containing an encryption key to access encrypted data in the digital disk.

### CROSS REFERENCE TO RELATED APPLICATIONS

This patent application is filed under 35 U.S.C. §120 as a Continuation-In-Part of and claiming priority to co-pending U.S. patent application Ser. Nos. 10/665,837, filed Sep. 18, 2003, and Ser. No. 10/702,530, filed Nov. 5, 2003; which in turn claim priority to co-pending U.S. patent application Ser. No. 10/165,273 filed Jun. 6, 2002; which in turn claims priority under 35 U.S.C. §119(e) to U.S. Provisional Application Ser. No. 60/296,308 filed Jun. 6, 2001, U.S. Provisional Application Ser. No. 60/310,914 filed Aug. 8, 2001, and U.S. Provisional Application Ser. No. 60/311,160 filed Aug. 9, 2001; this patent application further claiming priority under 35 U.S.C. §119(e) to U.S. Provisional Application Ser. No. 60/412,153 filed Sep. 18, 2002; and U.S. Provisional Application Ser. No. 60/489,945 filed Jul. 22, 2003. The disclosures of all of these applications are incorporated by reference herein.

### FIELD OF THE INVENTION

The present invention relates generally to systems and methods for digital data encryption, and more specifically, to systems and methods for providing encryption keys for reading encrypted data.

### BACKGROUND OF THE INVENTION

The emergence of digital technology, including audio and video recordings on digital disks which are optically read, has provided consumers with high quality audio and video entertainment. The improved format, while providing higher quality, also poses new threats to copyright owners through the unauthorized reproductions of digital disks. Through simple means typically available to anyone with a personal computer, consumers can easily make high quality unauthorized copies of copyrighted data in digital disks.

In order to prevent unauthorized reproduction of disks containing digital data, producers of digital disks encode digital data on the disk, and also provide an encryption key to access the data on the disk. Typically, a serial number or identification number is provided in machine-readable form to provide an access code for encryption. Encryption keys are well-known and prevent widespread reproduction of copyrighted material. With their increased use however, methods of cracking encryption keys to access the data have also been developed.

Another approach to protect copyrighted content is to embed a watermark into multimedia content such as audio and video, wherein these watermarks are imperceptible to the human eye. Detectors can be deployed in hardware or software to meet real-time play and record control requirements in a wide range of platforms like dvd. With an efficient detector implementation and robust watermark encoding, the watermark can survive a wide variety of professional and consumer analog-to-digital and digital-to-analog transformations and video processing.

Still another security technique involves the use of secure data types. Secure data types are enhanced protected integers that generate a secure environment less susceptible to protected function or emulation blackbox attacks. Secure data types compile into complex code, adding significant difficulty to formulas. The more secure data types that are implemented into the code, the greater the effort required to strip away the security of each secure data type.

These security systems nonetheless, suffer from natural limitations associated with the technology. Secure data types are limited in that security increases proportionally with the complexity and number of secure data types in the code, and as the complexity and number increase, so does its cost. Similarly, a conventional watermark detector must comprise some kind of memory, and the complexity of the watermark detectors is increasingly dominated by the RAM necessary to do its computations. This also leads to increased costs associated with the security system.

Additional problems, such as those associated with integrity and confidentiality, are also observed when watermark detectors share memory resources. The integrity problem involves that external RAM is reasonably easy to access, and a hacker wanting to obstruct the watermark detection function could replace the data stored by the detector through zeroes or dummy data before it is retrieved again by that detector. The confidentiality problem is illustrated by the fact that a hacker could glean information about the precise shape of the watermark by studying the data stored in the external memory.

There is a need therefore for a more efficient encryption system which is not cost-prohibitive, yet provides adequate safeguards against unauthorized reproduction.

### SUMMARY OF THE INVENTION

Provided herein is an information storage disk system. The information storage disk system is comprised of a readable disk including encrypted data, and a layer coating a surface of the readable disk. The layer includes a readable reflective pattern, and the readable pattern includes an encryption key to access the encrypted data.

In a non-limiting embodiment, the layer coating of the information storage disk system includes a cured polymer resin system. In another non-limiting embodiment, the polymer resin system includes a photoinitator, an acid catalyst, and a reactive polymeric unit. The reactive polymeric unit may be selected from a variety of acrylic groups.

In another non-limiting embodiment, the readable pattern is selected from the any image, text, or other graphical representation in the coating. The readable reflective pattern is therefore varied in response to a radial distance of the readable reflective pattern on the readable disk. In a non-limiting embodiment, the readable pattern may be concentric rings, radial lines, or any pattern capable of including an encryption key therein. The encryption key may also be varied in response to a radial distance of the encryption key on said readable disk. The encrypted data may also be encrypted using an encryption key in response to a radial location of the encrypted data on the readable disk. The information storage disk system may be one of a compact audio disc, and a digital versatile disk.

Provided also herein is a method of making an information storage disk system. The method is comprised of recording encrypted data on a readable disk, and then coating said disk with a polymeric coating including a readable pattern, the pattern including an encryption key to access the encrypted data.

In a non-limiting embodiment, the polymeric coating is formed by the method of: 1) spin coating a flowable polymer composition onto the readable disk, 2) masking the polymer composition with an optical mask, the mask including a pattern, and 3) curing the flowable polymer composition with actinic radiation passing through the mask. In an embodiment, the flowable polymer composition is cured by an acid-catalyzed curing reaction.

Provided also herein is a method of accessing information from an information storage disk system. The method comprises providing a readable disk with a polymeric coating. The readable disk includes encrypted data, and the polymeric coating includes a readable pattern. The pattern includes an encryption key to access the data. An encryption key is obtained in response to the readable pattern, The encrypted data is read then decrypted with the encryption key.

In a non-limiting embodiment, the method of obtaining the encryption key includes scanning the readable pattern using a first wavelength of light. Reading the encrypted data includes scanning the encrypted data with a second wavelength of light.

### BRIEF DESCRIPTIONS OF THE DRAWINGS

A fuller understanding of the advantages, nature, and objects of the invention may be had by reference to the following illustrative description, when taken in conjunction with the accompanying drawings. The drawings are not necessarily drawn to scale, and like reference numerals refer to the same items throughout the different views.

FIG. 1 is a cross-sectional diagram of a prior art digital disk.

FIG. 2 is a cross-sectional diagram of a digital media having a coating layer in accordance with the teachings herein.

FIG. 3 shows aspects of the digital reading and decryption system in accordance with the teachings herein.

FIG. 4 shows a pattern containing an encryption key in accordance with the teachings herein.

FIG. 5 shows a pattern containing an encryption key in accordance with the teachings herein.

FIG. 6 shows a pattern containing an encryption key in accordance with the teachings herein.

### DETAILED DESCRIPTION

Described herein are embodiments of an information storage disk system. The information storage disk system may be an optically read digital disk, such as an audio CD, or a DVD. The storage disk system includes a readable disk including encrypted data, and a layer coating a surface of said readable disk, the layer including a readable pattern. The readable pattern includes an encryption key to access the encrypted data.

The coating, as disclosed herein, is suited for incorporation into various components of optical media. It is recognized that a variety of optical media exist, and that many have a structure that differs, at least partially, from other optical media. Therefore, this disclosure teaches what are to be considered non-limiting embodiments of incorporating a coating into an optical media. That is, this disclosure does not provide an exhaustive disclosure of incorporation of the coating into optical media.

FIG. 1 discloses aspects of an exemplary optical media known in the prior art. The optical media 8 includes various layers, which may be referred to herein as “components” of the optical media 8. The substrate layer 16 is molded with pits 5 and lands 6 (data features), and is typically formed of polycarbonate or similar transmissive plastic material. A reflective layer 14 is deposited on the data features to enable readout by reflection of an interrogating laser beam. A protective layer 12 is one component that is typically included to ensure the integrity of the reflective layer 14 and is typically formed of a UV curable acrylate coating or similar material. The disc is read through the substrate layer 16, as indicated by the directional arrow in FIG. 1. Typically, printing or other indicia are placed over the protective layer 12.

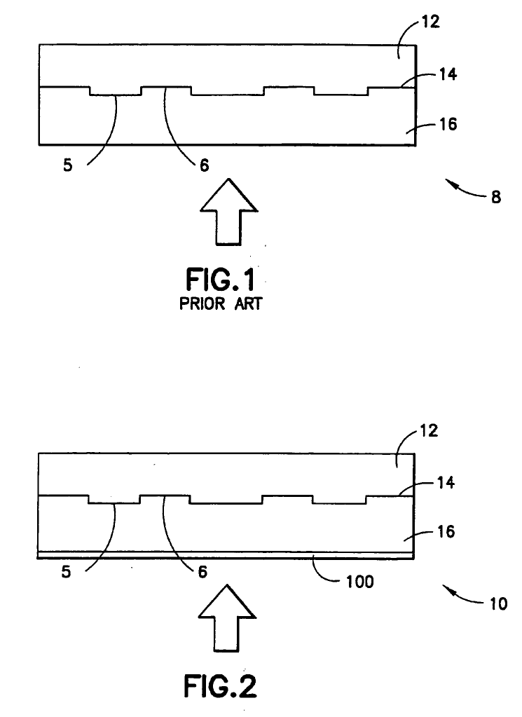

FIG. 2 provides an illustration of the cross section of an optical media 10 with a first and introductory embodiment of a coating 100 applied thereon. In this illustration, the information storage disk system 10 includes a reflecting layer 14 and a substrate layer 16. In typical embodiments, the substrate layer 16 is formed of polycarbonate, while the reflecting layer 14 is metallized (has a reflective metal applied thereon). It is recognized that aspects of the reflecting layer 14 and a substrate layer 16 are typically dictated by the specifications for the disk sytem 10, and therefore are generally not discussed further herein. The discs 10 typically contain pits 5 and lands 6 as data features. As disclosed herein, preferably, the coating 100 is applied over the substrate 16 of the optical media 8. In some embodiments, aspects of the substrate layer 16 may be adjusted to account for subsequent preparation of the coating 100. For example, the substrate layer 16 may be installed with a reduced thickness as determined by reference to a manufacturer's specification for the type of optical media 8. Subsequent installation of the coating 100 is then used to increase the thickness of the optical media 10 to meet the desired thickness specification.

Optical reading of digital data on disks is well known in the art. A compact disk or dvd containing data is scanned by a laser reader which reads data which has been stored on the disk surface. A detector attached to the laser reader transfers the data to a data buffer. The data is then decrypted by a decryptor, and the decrypted data is read, thus playing the audio or visual data.

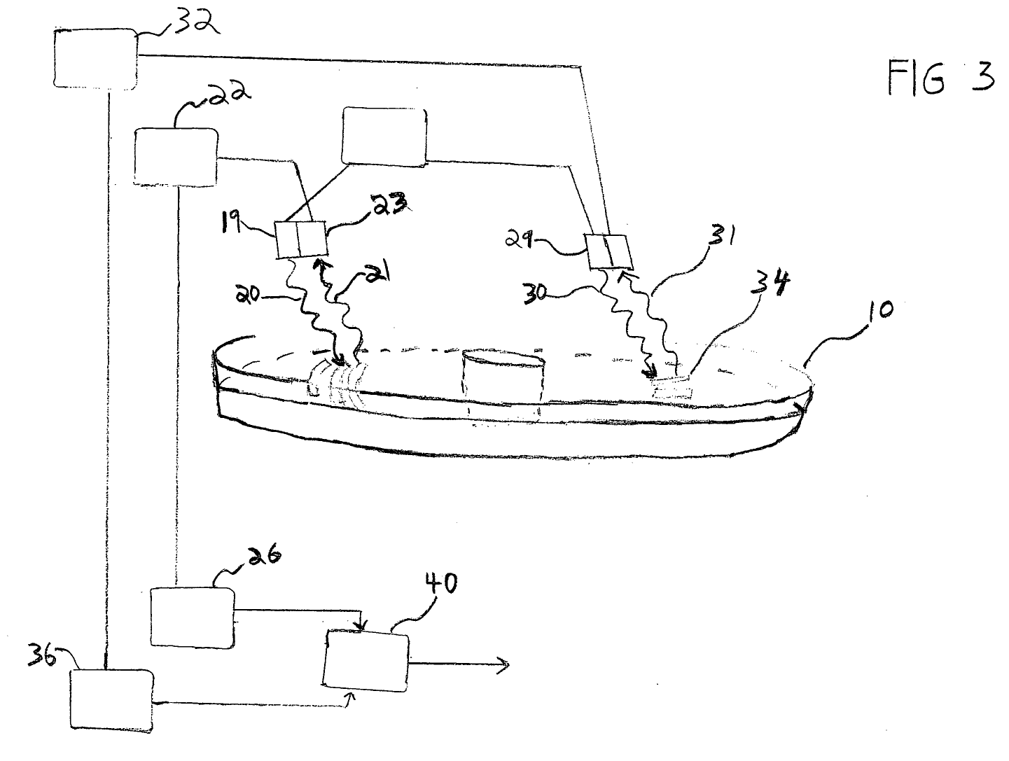

FIG. 3 shows a digital disk reader employing the method of the present invention. Disk 10 is scanned by a first laser beam 20 from an optical transmitter 19, and the encrypted data in pits 5 and lands 6 reflects the beam 20. The reflected light 21 is then received by an optical transceiver 23, and relayed to a first detector 22. From first detector 22, the information is communicated to first data buffer 26, which is in electronic communication with first detector 22. Finally, the information is transferred to decryptor 40, which is in electronic communication With first data buffer 26.

Similarly, second laser beam 30 emanates from optical transmitter 29, and scans disk system 10, reading a readable pattern 34 on coating 100. Readable pattern 34 selectively reflects laser 30, and reflected light 31 is received by optical transceiver 33. Pattern 34 contains an encryption key to access data contained in pits 5 and lands 6. The information, or data, is then relayed to second detector 32. From second detector 32, the information is communicated to second data buffer 36, which is in electronic communication with second detector 32. Finally, the information is transferred to decryptor 40, which is in electronic communication with second data buffer 36.

In one embodiment, first laser 20 and second laser 30 scan in synchronization with each other, and each follows the same track so that they are radially positioned at a substantially preselected spot on the disk at the same time. The dual first and second data streams are used by the decryptor to decrypt using the encryption code.

The laser beams 20 and 30 are of different wavelengths. First laser beam 20 has a wavelength selected to pass through pattern 34 on coating 100 substantially without attenuation. Second laser 30 is selected to be reflected by coating 100. The detectors 22 and 32 are designed to detect light from their respective lasers 20 and 30.

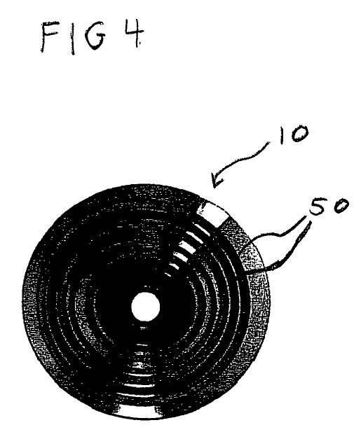

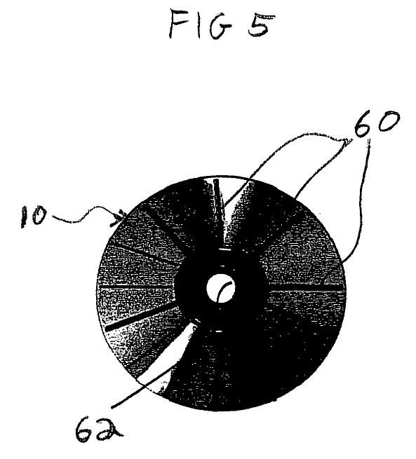

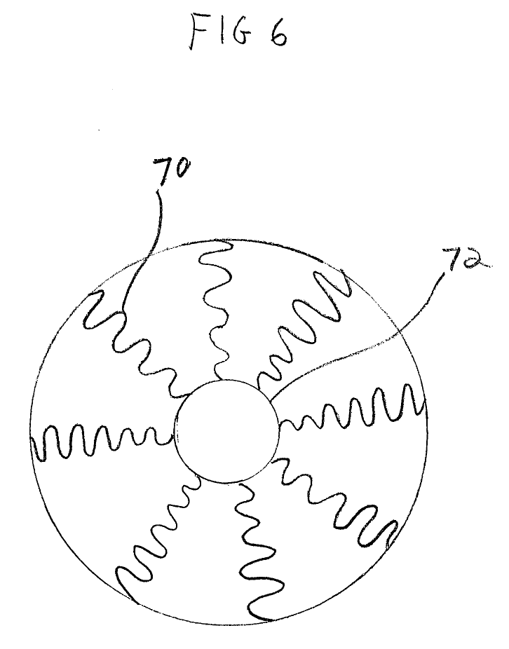

Many patterns are contemplated for pattern 34 containing the encryption key. The patterns are chromatically variable by color, opacity, shade, shape, and a variety of different variables. FIGS. 4-6 show some contemplated patterns. FIG. 4 shows a series of radially increasing rings 50 positioned on a surface of disk system 10. FIG. 5 shows radial lines 60 emanating from a center 62 of disk system 10. FIG. 6 shows a pattern 70 similar to a sine curve, in which the amplitude of the curve increases with its radial distance from a center 72 of the disk. Additional patterns are contemplated, including images, text, and other graphical representations in which the radial response of the readout laser can be varied in a controlled fashion.

Coating 100 contains color forming materials necessary for generation of a color image. The color forming materials may be configured in a variety of ways, to be discussed further herein. The color forming materials may be used to develop a gray scale, single color, or multi-color marking. The coating 100 does not interfere, or substantially interfere, with the readout of the optical media 10. That is, the coating 100 and any markings recorded in the coating 100, do not appreciably absorb or scatter light at the readout wavelength of the optical media readout laser. Likewise, the thickness and other aspects of the coating 100 do not substantially interfere with the readout mechanism.

In one embodiment, readable pattern 34 may also be varied with its radial distance on disk 10. The changing pattern 34 with increased radius corresponds to the encrypted data at a corresponding point of disk 10.

The coating 100 contains what can be referred to as two “sets” of photosensitive materials. One set of photosensitive materials provides for curing of the coating 100 once the coating 100 is in place. That is, exposure to one set of wavelengths provides for curing of the first set of photosensitive materials. A second set of photosensitive materials in the coating 100 exhibits optical changes upon adequate exposure to a separate set of wavelengths. Thus, the coating 100 may contain photoinitiators to initiate crosslinking. The coating 100 may include, but is not limited to, compounds such as photoacid or photobase generators, acid or base sensitive dyes, leucodyes, metal chelates, fluorescent dyes, or laser dyes. The coating 100 may be colored or colorless to the eye, and may be fluorescent under certain electromagnetic radiation. Fluorescent emission wavelengths may include, but are not limited to, a wavelength in the visible region.

Commonly used readout light wavelengths for the optical media 10 include 408 nm, 440 nm, 630 nm, 650 nm, and 780 nm, while other readout wavelengths are possible.

Although disclosed herein in terms of photosensitive materials responsive to wavelengths of ultraviolet light (UV), the coating 100 may include materials that are photosensitive to any band of wavelengths (also referred to as a “set of wavelengths”). For example, the photosensitive materials may be responsive to UV-A, UV-B, UV-C, VIS (visible wavelengths), short wavelength infrared (IR), IR, or long wavelength IR. As one may surmise, having two sets of photosensitive materials provides for use of two sets wavelengths to initiate the changes in the coating 100 as described herein. It is considered that other formulations, not discussed herein, may advantageously make use of wavelength separation over the spectrum of useful wavelengths. Accordingly, the teachings herein are not limited to the exemplary embodiments herein, which merely provide one example of a system for applying markings to optical media.

“Optical media” are referred to herein in general terms, such as “CD” or “DVD.” However, it is considered that optical media 8 encompass many different media formats. For example, the many formats of optical media 8 include: DVD 5, DVD 9, DVD 10, DVD 14, DVD 18, DVD-R, DVD-RW, CD-Audio, CD-Video, CD-R, CD-RW, CD-ROM, CD-ROM/XA, CD-i, CD-Extra, CD-Photo, Super-Audio CD, Mini-Disc a hybrid format, which may include any-one or more of the foregoing, Blu-Ray, and others. It is recognized that this is not an exhaustive list, and should therefore only be considered illustrative of the variety of optical media formats that may benefit from the use of this invention.

Aspects of the development of the coating materials are now presented. Some embodiments disclosed herein are results of experimentation. One skilled in the art will recognize that some embodiments provide certain advantages in certain settings over other embodiments. Further embodiments may also be developed. Therefore, it should be recognized that the formulations and the processes for making and applying a coating are illustrative and not limiting of the invention herein.

Early attempts to make a photosensitive color forming lacquer originated with a combination of acrylates, a photoinitiator, a photoacid generator (PAG), and a color former. One of the first formulations that was considered to show desired properties was composed of about 3% of a photoacid generator (PAG), about 3% of a color former, and about 94% of a mixture, referred to as a “coating base.” The coating base was formed of a mixture that included an acrylate and a photoinitiator. Presently preferred embodiments of the coating base are generally a mixture of acrylated monomers and oligomers, wetting agents, and a photoinitiator. The color former and the photoacid generator, referred to as the “imaging components” are added to the coating base.

Initial experimentation with the development of suitable coating base materials involved an acrylate combination where SR-494 and SR-238 were mixed in about equal quantities. A photoinitiator, ESACURE KTO-46, was added to the acrylate combination so as to be about 10% of the first coating base.

The chemical equivalents of these materials being: SR-494 is an ethoxylated (4) pentaerythritol tetraacrylate; SR-238 is a 1,6 hexanediol diacrylate having a low viscosity, fast curing monomer with low volatility, a hydrophobic backbone, and good solvency for use in free radical polymerization; and, ESACURE KTO-46 is a stable liquid mixture of trimethylbenzoyidiphenylphosphine oxide, .alpha.-hydroxyketones, and benzophenone derivatives. ESACURE KTO-46 is a liquid photoinitiator that can be incorporated by simply stirring into a resin system, and is insoluble in water and is soluble in most common organic solvents and monomers. KTO-46 may also be referred to as including ESACURE KIP-150 and ESACURE TZT. The equivalent of ESACURE KIP-150 being an: oligo [2-hydroxy-2-methyl-1-[4-(1-methylvinyl) phenyl] propanone]; and ESACURE TZT being an eutectic liquid mixture of: 2,4,6 trimethylbenzophenone and 4 methylbenzophenone.

ESACURE KTO-46, ESACURE KIP-150 and ESACURE TZT are produced by Lamberti Spa, Gallarate-Va, Italy. SR-494 and SR-238 are products of Sartomer Corporation of Exton, Pa. KTO-46 is also marketed by Sartomer Corporation as SARCURE-1135 (therefore, KTO-46 and SR-1135 are used interchangeably herein).

Experiments further revealed that applying the coating 100 to an optical media 10 could be achieved by various techniques. Preferably, the coating 100 is applied by spin coating. However, during initial applications of the coating 100 by use of spin coating, the edges of the optical media 10 occasionally exhibited coverage that was less than desired. It was determined that this was due to the high surface tension of the lacquer (coating base). Therefore, wetting agents were added to the coating base to improve substrate wetting and lower the surface tension were.

Multiple variations and modifications are possible in the embodiments of the invention described here. Although certain illustrative embodiments of the invention have been shown and described here, a wide range of modifications, changes, and substitutions is contemplated in the foregoing disclosure. In some instances, some features of the present invention may be employed without a corresponding use of the other features. Accordingly, it is appropriate that the foregoing description be construed broadly and understood as being given by way of illustration and example only, the spirit and scope of the invention being limited only by the appended claims.

What is claimed is:

1. An information storage disk system comprising:
A readable disk including encrypted data; and
A layer coating a surface of said readable disk, said layer comprising a readable pattern; said readable reflective pattern including an encryption key to access said encrypted data.

2. The information storage disk system of claim 1 wherein said layer comprises a cured polymer resin system.

3. The information storage disk system of claim 2 wherein said cured polymer resin system comprises a photoinitator, an acid catalyst, and a reactive polymeric unit.

4. The information storage disk system of claim 3 wherein said reactive polymeric unit comprises an acrylic group.

5. The information storage disk system of claim 3 wherein said cured polymer resin further comprises a second photoinitiator, and wherein said photoinitiaor and said second photoinitiator are activated by different wavelengths of radiation.

6. The information storage disk system of claim 5 wherein said second photoinitiator initiates optical changes to said layer coating upon activation by a preselected wavelength of radiation.

7. The information storage disk system of claim 1 wherein said readable pattern is selected from the group of concentric rings and radial lines.

8. The information storage disk system of claim 1 wherein said readable pattern is varied in response to a radial distance of said readable pattern on said readable disk.

9. The information storage disk system of claim 1 wherein said encryption key is varied in response to a radial distance of said encryption key on said readable disk.

10. The information storage disk system of claim 9 wherein said encrypted data is encrypted using an encryption key in response to a radial location of said encrypted data on said disk.

11. The information storage disk system of claim 1 wherein said information storage disk system comprises one of a compact audio disc, and a digital versatile disk.

12. A method of making an information storage disk system comprising:
Recording encrypted data on a readable disk; and
Coating said disk with a polymeric coating including a readable pattern, said pattern including an encryption key to access said encrypted data.

13. The method of claim 12 wherein said polymeric coating is formed by the method comprsing:
Spin coating a flowable polymer composition on said readable disk;
Masking said polymer composition with a mold including a pattern; and
Curing said flowable polymer composition with actinic radiation.

14. The method of claim 13 wherein curing said flowable polymer composition comprises an acid-catalyzed curing reaction.

15. The method of claim 12 wherein said polymeric coating comprises a photoinitator, an acid catalyst, and a reactive polymeric unit.

16. The method of claim 15 wherein said reactive polymeric unit comprises an acrylic group.

17. The method of claim 13 further comprising initating optical changes in said polymeric coating by activating second photoinitiators with actinic radiation.

18. The method of claim 12 wherein said readable reflective pattern is selected from the group of concentric rings and radial lines.

19. The method of claim 12 wherein said readable reflective pattern is varied in response to a radial distance of said readable reflective pattern on said readable disk.

20. The method of claim 12 wherein said encryption key is varied in response to a radial distance of said encryption key on said readable disk.

21. The method of claim 20 wherein said encrypted data is encrypted using an encryption key in response to a radial location of said encrypted data on said disk.

22. A method of accessing information from an information storage disk system comprising:
Providing a readable disk with a polymeric coating, said readable disk including encrypted data, said polymeric coating including a readable pattern; said pattern including an encryption key to access said data;
Obtaining said encryption key in response to said pattern;
Reading said encrypted data; and
Decrypting said encrypted data with said encryption key.

23. The method of claim 22 wherein obtaining said encryption key comprises scanning said reflective readable pattern using a first wavelength of light and wherein reading said encrypted data comprises scanning said encrypted data with a second wavelength of light.

24. The method of claim 22 wherein said information storage disk system comprises one of a compact audio disc, and a digital versatile disk.
